(19) United States
(12) Patent Application Publication
(10) Pub. No.: US 2005/0229159 A1
(43) Pub. Date: Oct. 13, 2005

(54) Version aware test management system and method

(75) Inventors: Erez Haba, Redmond, WA (US); Sam Guckenheimer, Kirkland, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/822,454

(22) Filed: Apr. 12, 2004

(51) Int. Cl. G06F 9/44

(52) U.S. Cl. 717/122; 717/124

(57) ABSTRACT

The present invention provides for a test management system that maintains fine-grained versioning information without sacrificing query, filtering, and reporting capabilities. Metadata associated with a test is stored in an XML file that is versioned with the test assets and source code. Furthermore, the XML file can contain all the attributes necessary for query and management, for example via XSLT transformations.

### TECHNICAL FIELD

The present invention relates generally to computers and more particularly toward automated software application testing.

### BACKGROUND

Software application testing systems have been around for quite some time. Testing systems are fueled by consumer demand for high quality and reliable software. Accordingly, newly developed or extended software applications will not be released by software development companies until and unless they pass the tests developed for them (e.g., functional, load, unit, integration . . . ). Testing begins by clearly and completely defining requirements for a software application (e.g., functional requirements, performance requirements . . . ). These requirements can be employed to more clearly delineate the scope of an application in development. A test plan can then be devised that captures requirements, for example by dividing an application up into functional units. Thereafter, tests can be designed and developed that examine application functions in terms of expected results, for instance. If upon test termination functional unit values are different than expected results, then the application has failed the test. Accordingly, the software under test will or has failed to meet a defined application requirement. Subsequently, defects can be analyzed and fixes applied to the code. One or more tests can then be re-executed and the process repeated until successful.

Fortunately, developers and testers do not have to tackle software testing manually. Presently, there are various software test management systems that automate all or part of the testing process. However, effective software testing has two requirements that are in conflict in conventional test management systems. First, large amounts of data need to be accessible in a form that provides ready querying and reporting, to view exception patterns, trends, productivity, success rates, among other things, over the breadth of a team and over the course of a software lifecycle. Second, individual tests are intimately tied to specific versions of software under test (SUT). Both the tests and the SUT are updated frequently, although often at different times, and the versions need to be correctly matched to provide accurate test results.

Conventionally, there are two divergent approaches to persistence in software test management. Test management data can be stored in a relational database, optimized for querying and reporting. For example, Mercury TestDirector and IBM Rational TestManager utilize this approach. However, this creates a problem in that the database reflects a snapshot in time and as a consequence tests and source cannot be kept in sync unless all development assets are backed up (baselined) at once, which is typically only done sparingly (e.g., product ships, beta releases . . . ). This has been the favored approach for managing testing activities in teams. An alternative approach is to store tests as source code with granular version control consistent with the source code. For instance, open source frameworks NUnit (for .Net) and JUnit (for Java) utilized this approach. This allows tests and source under test to be synchronized but prevents the querying and reporting that are necessary for managing a testing effort across a team of any size. Accordingly, this approach has been used for testing performed by individual programmers on their own code, but not employed for team activity.

Accordingly, there is a need in the art for a single test management system that maintains versioning of tests and their relationships to software under test, without sacrificing querying, filtering, and reporting.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention resolves conventional competing requirements and provides for a single test management system to maintain fine-grained versioning of tests and their relationship to software under test, without sacrificing querying, filtering, and reporting. In particular, the subject invention stores metadata associated with one or more tests in an XML file that is versioned with the test assets and source code. In other words, fine-grained versioning information is explicitly specified. This is significant, as source code gets versioned many times throughout a software development lifecycle. Accordingly, a tester needs to know which version of software is being tested by which test, as test results may not be comparable because the source code under test may have changed. Conventional large scale approaches are not explicit about versioning and thus are of little value for trending an analysis.

According to an aspect of the invention, the XML file, also referred to as the Test Case XML (TCX) file, can also include all of the attributes necessary for query and management including pointers to source under test, requirement under test, configuration under test, and other aspects needed for filtering, in addition to versioning data. Persisting metadata to the TCX file allows versioning consistent with a source and version-aware references to the source under test (SUT).

According to another aspect of the subject invention, TCX data can be loaded into memory or treated as a database via XSLT transformation, for example, in order to allow management operations including but not limited to selection, query, reporting, suit composition, and scheduling.

In brief, the subject invention keeps fine-grained track of tests' relations to the version of software under test and at the same time preserves query ability, thus providing, among other things, a union of benefits from the conventional conflicting approaches employed today.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram depicting a test management system in accordance with an aspect of the subject invention.

FIG. 2a is a schematic block diagram of a catalog component in accordance with an aspect of the present invention.

FIG. 2b is a schematic block diagram of a sample catalog file in accordance with an aspect of the present invention.

FIG. 2c is a schematic block diagram of two linked catalog files in accordance with an aspect of the subject invention.

FIG. 3 is a schematic block diagram illustrating key test component relationships in accordance with an aspect of the subject invention.

FIG. 4 is a schematic block diagram of a storage system in accordance with an aspect of the subject invention.

FIG. 5 is a flow chart diagram of a test management methodology in accordance with an aspect of the subject invention.

FIG. 6 is a flow chart diagram of a test management methodology in accordance with an aspect of the present invention.

FIG. 7 is a flow chart diagram of a testing methodology in accordance with an aspect of the subject invention.

FIG. 8 is a schematic block diagram illustrating a suitable operating environment in accordance with an aspect of the present invention.

FIG. 9 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. For example, a computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope or spirit of the subject invention.

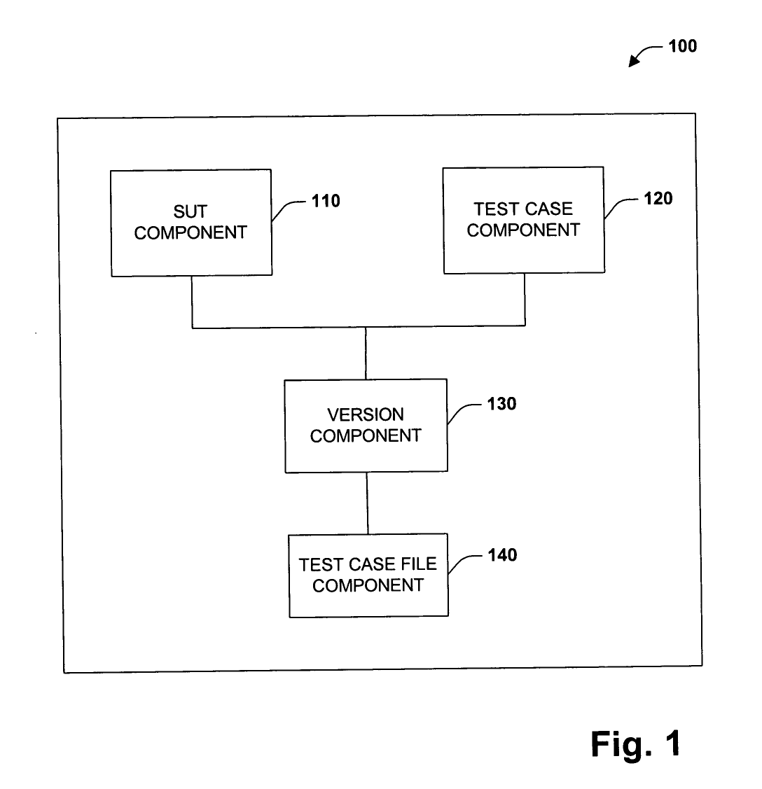

Turning initially to FIG. 1, a test management system 100 is illustrated in accordance with an aspect of the present invention. Test management system 100 comprises software under test (SUT) component 110, test case component 120, version component 130, and test case file component 140. The test management system 100, at least in part, provides a system or subsystem that facilitates coherent interaction between and amongst developers and testers over a software lifecycle. Accordingly, it should be appreciated that although not shown developers and testers may interact with various test management system components to view data and/or effectuate changes. SUT component 110 includes and refers to a software application that has been developed or is in the process of being developed by one or more developers. A developer can be a person that authors product source code. Furthermore, it is to be appreciated that SUT can also refer to System Under Test as the software in fact defines a unique computing machine or system. Test case component 120 corresponds to a formal description of an individual test perhaps including but not limited to test script(s), test input/stimulus, and test conditions needed for execution of the test. The test management system 100 also includes a version component 130. Version component 130 monitors both the SUT component 110 and the test component 120 for changes. For example, component 130 can detect a version change in the source code under test. This can, inter alia, help ensure the elimination of many false positive results that may otherwise occur during testing if it was not so noted that the source under test had changed, for instance.

Test case file component 140 receives or retrieves version data from version component 130 regarding particular source code and tests, and stores them to a file such as an XML (extensible Markup Language) file. In essence, the XML file can store metadata associated with tests and source code. Additionally, the file can contain all the attributes necessary for query and management including but not limited to pointers to the source under test, requirements under test, configuration under test, and other aspects necessary for filtering. Persistence to the test XML file enables fine-grained versioning consistent with source as well as version-aware references to the source under test. Furthermore, according to an aspect of the present invention, the XML file data can be loaded into memory or treated like a database utilizing XSLT transformation, for instance, in order to provide management operations including but not limited to selection, query, reporting, suite composition and scheduling. Hence the present invention provides a union of benefits of conventional conflicting approaches including enabling querying and reporting as well as synchronization of tests and sources under test.

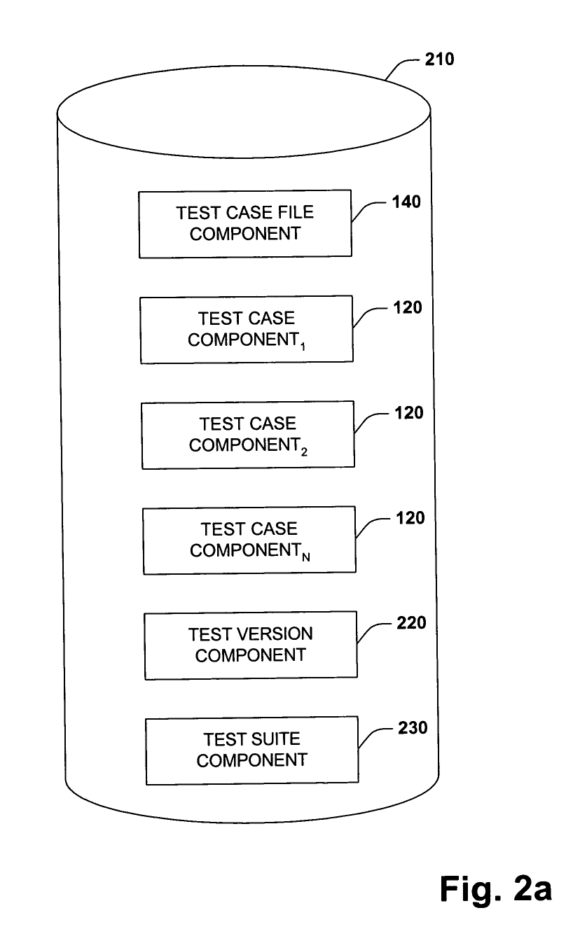

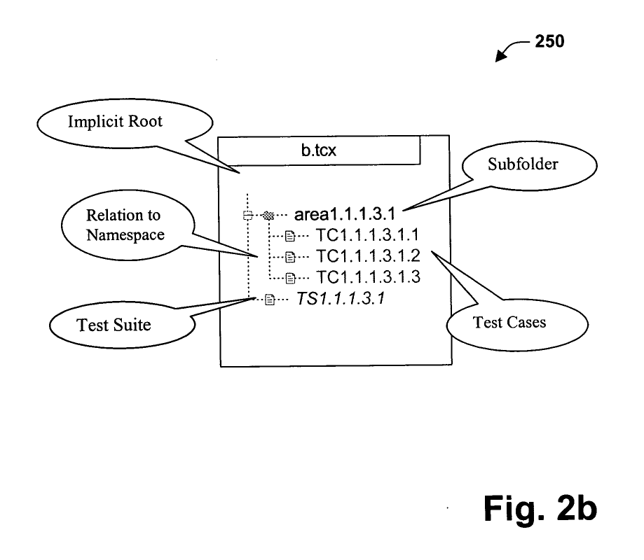

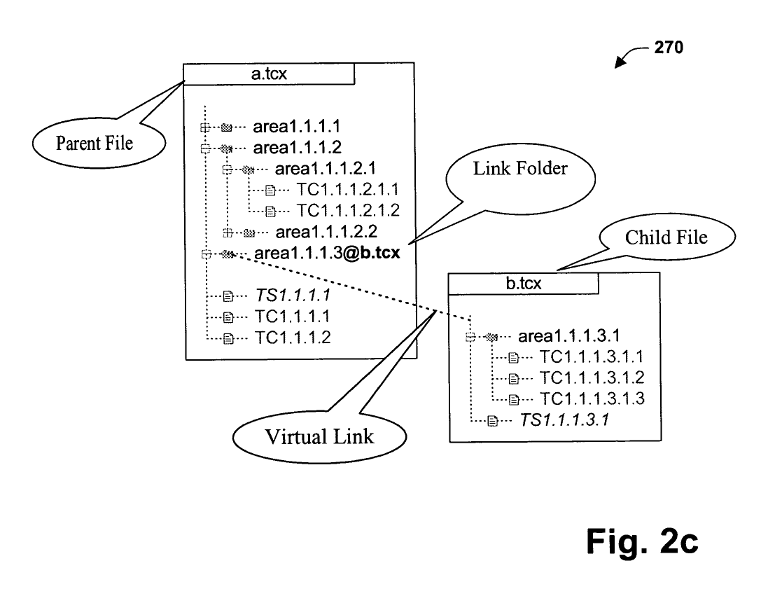

Turning to FIG. 2a, a test catalog 210 is illustrated in accordance with an aspect of the subject invention. The test catalog 210 provides a repository for a collection of test case files 140, test cases 120, test variations 220, and test suites 230, inter alia. The test catalog design 210 provides a data store layout which is simple, extensible, and scalable as well as enabling as users can manage a central store and/or their own local store using familiar concepts. The test catalog store 210 can be based on simple file storage, extended to create a hierarchical store. In particular, the catalog 210 can be constructed from the aggregation of individual files (e.g., TCX files), which relate to each other in a hierarchical fashion. A single file, such as a TCX file (also referred to herein as test case file), is the standard unit for a simple test catalog. The TCX file is a complete store for namespace metadata, test case, and test suite metadata, as well as their namespace relations.

Turning briefly to FIG. 2b, a simple exemplary catalog file 250 is illustrated in accordance with an aspect of the invention. As shown the file b.tcx can have an implicit root namespace folder, with test suit TS1.1.1.3.1, and subfolder b1.1.1.3.1 associated with it. In the same file 250, three test cases are stored as well as their relation to the b1.1.1.3.1 subfolder (the subfolder contains these test cases).

It should be appreciated that the namespace hierarchy stored in one TCX file can extend its namespace and store onto another TCX file, creating a father-child relationship between the two files. Turning to FIG. 2c, two linked catalog files 270 are depicted in accordance with an aspect of the invention. As shown the namespace hierarchy under folder a1.1.1.3 (in a.tcx) is extended onto the namespace stored in b.tcx. The folder a1.1.1.3 represents the entire sub-tree stored in b.tcx by logically replacing b.tcx implicit root folder in the merged namespace. The existence of such a link creates a father-child relation between the files a.tcx and b.tcx.

Returning to FIG. 2a, it should be appreciated that test catalog 210 can be specified in the form of a high performance database (e.g., SQL server) or as a text file (e.g., XML catalog for revision control). According to an aspect of the subject invention a user can create a test catalog, save changes to a test catalog, as well as import or export the test catalog or a subset thereof (e.g., to an XML file-TCX file).

As shown in FIG. 2a, exemplary test catalog 210 comprises a plurality of test case components 120 (Test Component₁, Test Component₂ through Test Component_{N}, where N is an integer greater than or equal to one). Test cases 120 can be formal definitions of individual tests including but not limited to test script(s), test input/stimulus, and test conditions necessary for the execution of the described test. A test author can create and customize tests cases 120 in a multitude of different manners. For example, a tester can create a test case entry and specify its hierarchy in the test catalog 210. In addition, the test case type can be specified (e.g., manual, automatic, unit, load, functional . . . ). It should also be appreciated that once the test case is specified it can later be edited or copied. For instance, a hierarchy sub-tree can be copied to another location in the hierarchy, test cases can be associated with requirements, test binaries, or a test project. Test variations 220 can also be included in the test catalog. Test variations 220 refer to a test artifact representing a test case with partially specialized parameter binding. Test variations 220 can be generated manually or automatically, for instance with a test rig. A test rig as used herein refers to hardware and/or software utilized to host a text execution. Finally, test catalog component 210 can also comprise one or more test suite components 230. Test suites 230 can be collection of test components (e.g., multiple test cases, hierarchy of test cases . . . ).

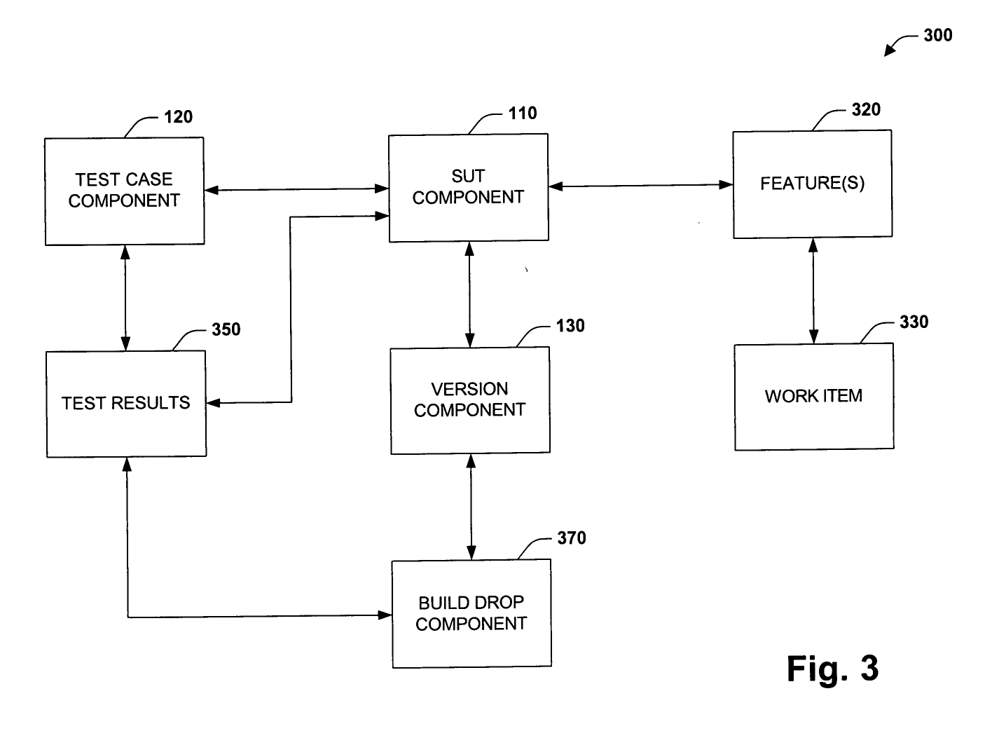

To facilitate a clear understanding of the interaction between particular test components FIG. 3 has been provided. FIG. 3 is a schematic block diagram 300 illustrating the key data component relationships in accordance with an aspect of the subject invention. Source under test (SUT) component 110 represents the computer system source code. The SUT component implements such functionality on a computer system, which provides particular features 320. Furthermore, such feature(s) can be implemented by way of a work item 330. In other words work items are implemented by features of the SUT component 110. Test case component 120 provides tests including but not limited to scripts and input/simulation data to examine or test the SUT component 110. The SUT component 110, the feature(s) 320 and the test case component 120 all represent versioned data. Stated somewhat differently, each component can and often does change. During the development process code 110 is continuously modified such that new features are added and/or removed. Furthermore, test case components 120 need to change to test the changes in the source under test 110. Test case component 120 generates test results 350. Test results 350 cover or correspond to the results of the test as executed on the current version of SUT 110. Version component 130 monitors and records changes to the SUT component 110. Build drop component 370 comprises the executable version of the software under test. The build drop component includes a changed data from the version component. Accordingly, the test results, the version component changes, and the build drop are all version tagged data, meaning that they are all dependent on the version of the software under test.

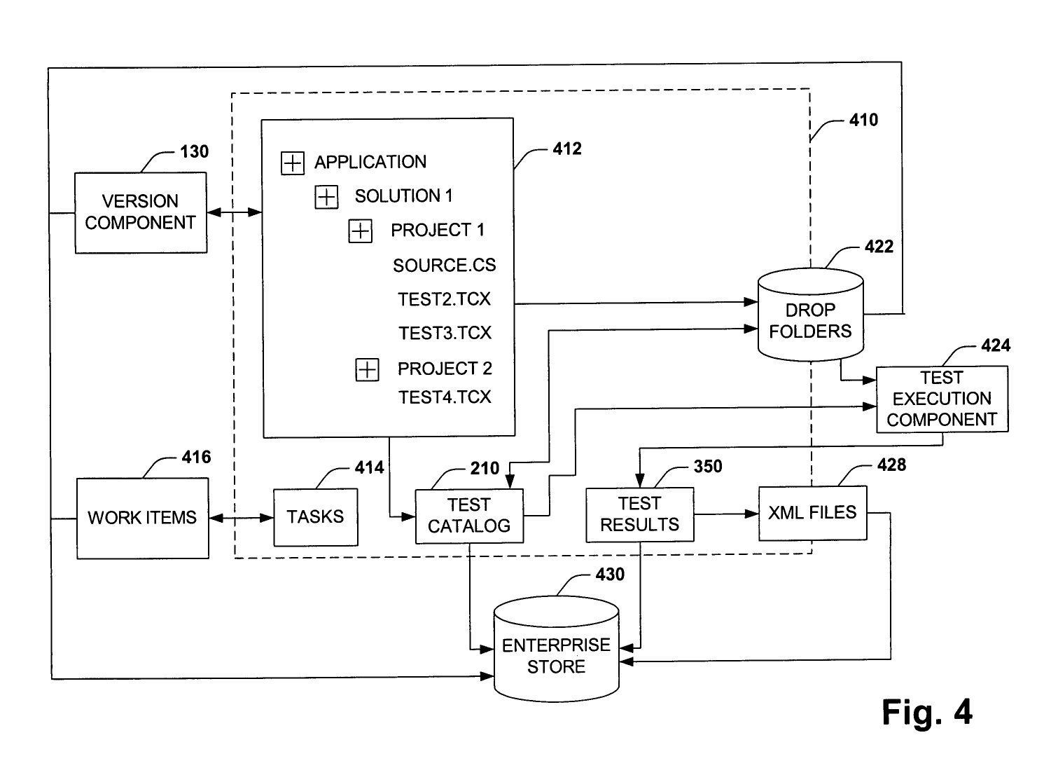

FIG. 4 depicts a storage system 400 in accordance with an aspect of the subject invention. Workspace 410 defines a boundary for isolation between transacted changes and version control. Application 412 provides instructions for executing tasks 414 on work items or data 416. Application 412 comprises a plurality of sections and tests integrated therein to facilitate synchronization. Version component 130 provides for source code version control. In essence, version component 130 monitors and tracks changes to the application 412 including tests residing therein. Test catalog 210 includes, inter alia, test cases, each test case having properties and file associations (e.g., paths). The test catalog 210 can be based on simple file storage, extended to create a hierarchical store. In particular, the test catalog 210 can be constructed from the aggregation of individual files such as XML files (also referred to herein as TCX (Test Case XML) files). A development team can share a centralized test catalog 210, which can be a database executing SQL server, for instance. Alternatively, individual members can have their own local test catalog 210, if desired. The test catalog 420 can be loaded with tests and other data from application 412. It should be appreciated that persistence in a TCX file in the test catalog 210 allows versioning consistent with a source as well as version-aware reference to a source under test. Application 412 can also be published to drop folder(s) 422 to provide a single reference point for testing. Additionally, test catalog 416 can interact with drop folder(s) 422 to archive and reload source code and test cases thereby supporting reversion. Text information from test catalog 420 and application source code residing in drop folder(s) 422 can be provided to a test execution component 424, which executes specified tests on the application source code. Subsequently, the test execution component 424 can provide test results 350. The test results 350 are then tagged and saved to XML files 428 which can thereafter be published to the enterprise data store 430. Furthermore, test catalog data 210 and test results 350 can be published directly to the enterprise data store 430 as version tagged data for historical and trend analysis. Additionally, the enterprise data store 420 can store drop folder data, source code, and work items.

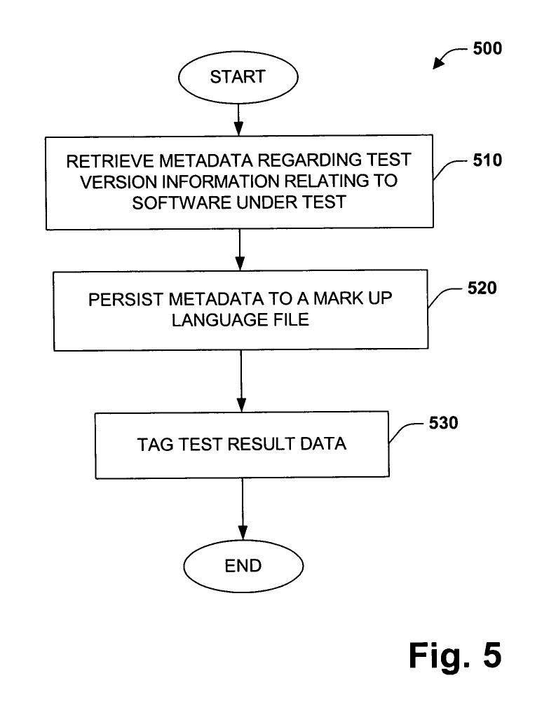

In view of the exemplary system(s) described supra, a methodology that may be implemented in accordance with the present invention will be better appreciated with reference to the flow charts of FIGS. 5-7. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media. By way of illustration and not limitation, the article of manufacture can embody computer readable instructions, data structures, schemas, program modules, and the like.

FIG. 5 depicts a method of test management 500 in accordance with an aspect of the subject invention. At 510, metadata is retrieved regarding test version information relating to a source or software under test. In other words, what is received is data defining current relationships between tests and source code under test such that it can be determined whether a test tests a the current version of code or an old version of the code, and how the test results relate to the present code under test. Thus, if a test relates to a particular code version then results generated by the test on subsequent source code versions may not be comparable because of the changes thereto. Furthermore, it should be appreciated that at least a portion of the metadata regarding versions can come from a version component or conventional source code control system. Still further yet it should be appreciated that according to an aspect of the present invention such version metadata can be employed in daily builds and testing. At 520, the metadata is persisted to a mark up language file such as XML, which provides a mechanism for defining or marking up data. At 530, test result data is version tagged to enable expeditious review of results with respect to the source code tested and the tests thereon. Storage of information in the manner described provides for explicitly specifying test source code relationships as well as easy data queries, for example via XSLT transformations.

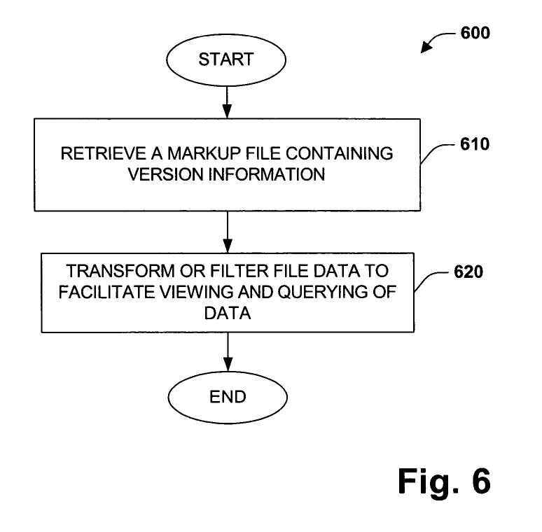

FIG. 6 depicts a test management methodology 600 in accordance with an aspect of the present invention. At 610, a markup file (e.g., XML) is retrieved, for instance from a test catalog. The XML file defines relationships between tests and versions of source code under test. Thereafter, at 620, the XML document is queried or filtered utilizing XSLT transformations, for example. Such transformations can provide a developer or manager a mechanism for viewing exception patterns, trends, productivity, success rates, and the like over the breadth of a development team and over the course of a software lifecycle. Additionally such XSLT transformations of an XML version document can facilitate report generation, test suit composition, and scheduling, inter alia.

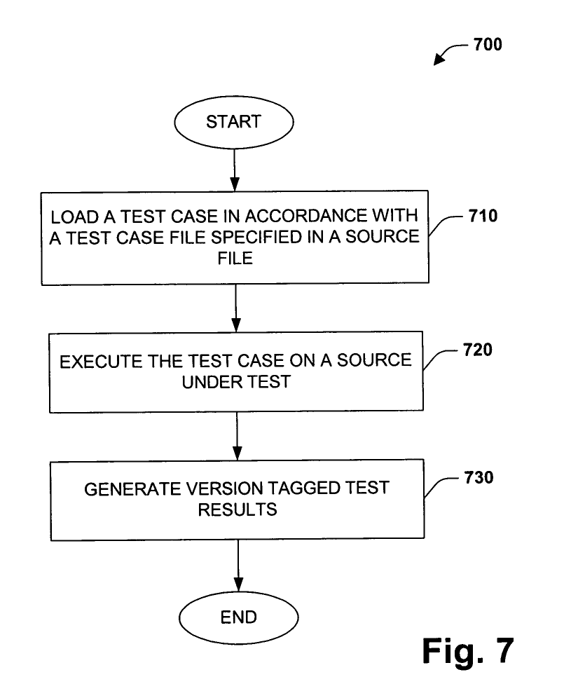

FIG. 7 illustrates a testing methodology in accordance with an aspect of the subject invention. At 710, a test case component corresponding to a test case file component is loaded. For example, the test case file component could provide a pointer to the test case component. The test case component could reside in an enterprise data store, for example. Next, at 720, the test case is executed on a source under test. At 730, version tagged test results are generated. In other words test results are produced and tagged with the version of the source under test and/or the test component. This is beneficial for historical or trend analysis. Test results could then be saved directly to an enterprise data store. Additionally or alternatively, the test results could be saved as an XML file and then saved to the enterprise data store.

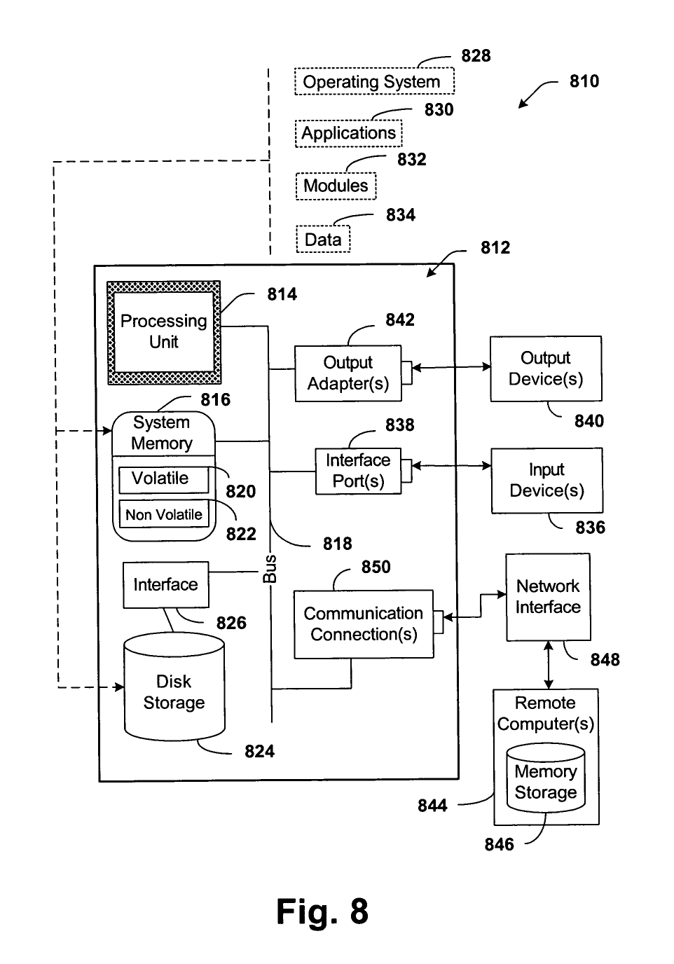

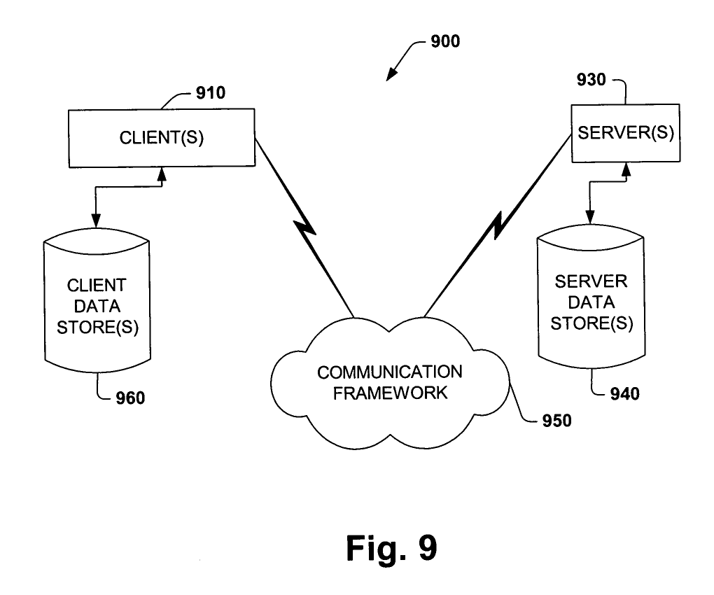

In order to provide a context for the various aspects of the invention, FIGS. 8 and 9 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example disk storage 824. Disk storage 4124 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. Furthermore, it is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, touch screen, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812 and to output information from computer 812 to an output device 840. Output adapter 842 is provided to illustrate that there are some output devices 840 like monitors, speakers, and printers, among other output devices 840 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems, DSL modems, power modems, ISDN adapters, and Ethernet cards.

FIG. 9 is a schematic block diagram of a sample-computing environment 900 with which the present invention can interact. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the present invention, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes or having” is used in either the detailed description or the claims, such term is intended to be inclusive in a manner similar to the term “comprising” as “comprising” is interpreted when employed as a transitional word in a claim.

1. An application test management system comprising:
a version component that monitors source under test components and test components for changes; and
a test case file component that includes versioning metadata associated with test case and source under test components received from the version component and attributes necessary for query and test management.

2. The system of claim 1, wherein the test case file component includes a pointer to the source under test.

3. The system of claim 1, wherein the test case file component includes a pointer to requirement for test data.

4. The system of claim 1, wherein the test case file component includes a pointer to requirement and/or configuration under test data.

5. The system of claim 1, wherein the test case file component includes a pointer to a test case component.

6. The system of claim 1, wherein the test case file component is loaded into memory or treated as a database to facilitate management operations including at least one of query, reporting, suite composition and scheduling.

7. The system of claim 1, wherein the test case file component is an XWL document.

8. The system of claim 7, wherein XSLT is employed to facilitate management operations including at least one of selection, query, reporting, suit composition, and scheduling.

9. The system of claim 1, wherein the test case file component is located in the source file under test.

10. The system of claim 9, wherein the test case file component is loaded into a test catalog.

11. The system of claim 8, wherein the test case component specified in the test case file component is loaded into the test catalog.

12. The system of claim 11, wherein a test execution component executes the test case on the software under test and generates test results.

13. The system of claim 12, wherein the test results are tagged with the test case component and source under test component versions for historical and/or trend analysis.

14. A test management system comprising:
a means for maintaining fine-grained track of a test's relation to a version of software under test; and
a means for querying test data to facilitate generation of test management reports.

15. The system of claim 14, wherein the means for maintaining fine-grained track of a test's relation to a version of software under test includes persisting software version information and related test information to an XML file.

16. The system of claim 15, wherein the XML file is transformed utilizing XSLT to enable test data to be queried.

17. A test management methodology comprising:
retrieving metadata regarding test version information in relation to software under test; and
persisting the metadata to a markup language file versioned with test assets and source code.

18. The method of claim 17, wherein version information is retrieved from a version component that monitors changes to source code versions.

19. The method of claim 17, wherein the file is an XML file.

20. The method of claim 19, wherein the file comprises a pointer to at least one of a source under test, requirement under test, and configuration under test.

21. The method of claim 19, further comprising transforming the XML file utilizing XSLT to enable management operations to be performed on the data including at least one of selection, query, reporting, suit composition, and scheduling.

22. A computer readable medium having stored thereon computer executable instructions for carrying out the method of claim 17.

23. A testing methodology comprising:
loading a test case in accordance with a test case file stored in a source file;
executing the test case on a source under test; and
generating test results, wherein the test results are version tagged.

24. The method of claim 23, further comprising saving test results to an XML file.

25. The method of claim 23, further comprising publishing the test results to an enterprise data store.

26. The method of claim 23, wherein the version tags indicate the version of the source under test and the version of the test.

27. A computer readable medium having stored thereon computer executable instructions for carrying out the method of claim 23.
